(19) United States
(12) Patent Application Publication
(10) Pub. No.: US 2008/0223680 A1
(43) Pub. Date: Sep. 18, 2008

(54) Automated Shift Transmission and Automated Friction Clutch

(75) Inventors: Wilhelm Hardtle, Markdorf (DE); Ludger Ronge, Eriskirch (DE); Frank-Detlef Speck, Langenargen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/089,112

(22) PCT Filed: Nov. 17, 2006
(86) PCT No.: PCT/EP06/11024

§ 371 Date: Apr. 3, 2008

(30) Foreign Application Priority Data
Nov. 19, 2005 (DE) 10 2005 055 210.2

(51) Int. Cl. F16D 13/00

(52) U.S. Cl. 192/31

(57) ABSTRACT

The invention concerns an automated transmission, for example a multi-stage motor-vehicle shift transmission, with at least one controllable actuating drive provided as a gear actuator (26) to engage and disengage a gear of the transmission or as a clutch actuator (7) to engage and disengage an associated automated engine clutch, and an automated friction clutch, for example an automated engine clutch arranged in the drivetrain of a motor vehicle between a drive engine and a transmission, with a controllable actuating drive provided as the clutch actuator (7) for engaging and disengaging the friction clutch.

To improve the controllability and achieve a longer service life while reducing production costs, it is proposed to use as the actuating drive (7, 26) a pneumatic muscle (8, 8.1, 8.2) with a hose body (9) made of a fluidically impermeable and elastic material with a lattice network (10) of tension-resistant fibers arranged in the outer area on the hose body (9), and with end pieces (11a, 11b) that close off the hose body (9) axially at its ends.

This application is a national stage completion of PCT/EP2006/011024 filed Nov. 17, 2006, which claims priority from German Application Serial No. 10 2005 055 210.2 filed Nov. 19, 2005.

### FIELD OF THE INVENTION

The invention concerns an automated shift transmission, in particular a multi-stage motor vehicle shift transmission, with at least one controllable actuating drive provided as a gear actuator to engage and disengage a gear of the transmission or as a clutch actuator to engage and disengage an associated automated engine clutch.

The invention also concerns an automated friction clutch, in particular an engine clutch arranged in the drivetrain of a motor vehicle between a drive engine and a transmission with a controllable actuating drive provided as the clutch actuator for engaging and disengaging the friction clutch.

### BACKGROUND OF THE INVENTION

In motor vehicles of both the passenger and commercial vehicle sectors, the use of automated transmissions is increasing, due to their relatively low weight, compact dimensions and high transmission efficiency resulting from their automated shift processes, they offer great operating comfort and, by using corresponding ecological shift control programs, they reduce the fuel consumption of the vehicle concerned. Associated with each automated transmission there is on the drive unit side thereof, as the engine clutch, an automated friction clutch usually made as a single disk dry clutch which, for starting and shift processes, is automatically engaged or disengaged by an associated clutch actuator.

Semi-automatic transmissions are also known in which gearshifts are carried out directly by the driver by way of shift actuating and shift transfer elements such as a shift lever, shift linkages and transmission-internal shift shafts and shift bars, while the engine clutch upstream therefrom on the drive input side is automatically actuated, i.e., disengaged or engaged, by a clutch actuator in coordination with the shift process.

Until now the actuating drives used are mainly hydraulic or pneumatic operating cylinders and electric motor or electromagnetic drives. Although operating cylinders that can be actuated by a pressure medium, via associated controlled magnetic valves, are indeed tried, tested and fully developed, their operating principle is such that because of a pre-filling phase and a long signal chain from the associated electronic control unit through the magnetic valve to the operating cylinder concerned, their response behavior is relatively poor, which can be unfavorable for the control of rapid shift processes.

Although it is true that electric actuating drives show fundamentally more rapid response behavior, owing to the marked hysteresis behavior associated with the magnetization, they are not suitable for rapid changes of the direction of movement. All these actuating drive structures have in common that they are relatively heavy; they entail high production costs because they contain numerous high-precision mechanical components and, since they incorporate running and sealing surfaces and/or rotary bearings affected by friction, they have a service life limited because of wear, and also demand a certain amount of effort and expenditure for maintenance and repair.

Against this background, the purpose of the present invention is to propose an actuating drive for an automated transmission and an automated friction clutch which, while having a simple and inexpensive structure, shows improved control behavior and has a longer service life.

This objective is achieved by an automated transmission with at least one controllable actuating drive, which is provided as a gear actuator for engaging and disengaging a gear of the transmission or as a clutch actuator for engaging and disengaging an associated automated engine clutch. In addition, it is provided that the actuating drive is made as a pneumatic muscle with a hose body made of a fluidically impermeable and elastic material with a lattice network of tension-resistant fibers arranged in the outer area on the hose body and with end pieces that close off the hose body at its ends.

The objective concerning the automated friction clutch is achieved by an automated friction clutch with a controllable actuating drive serving as a clutch actuator for engaging and disengaging the friction clutch. The actuating drive is made as a pneumatic muscle with a hose body made of a fluidically impermeable and elastic material with a lattice network of tension-resistant fibers arranged in the outer area on the hose body and with end pieces that close off the hose body at its ends.

The lattice network on the hose bodies is preferably made as a diamond-shaped mesh.

The pneumatic muscle, often called a Fluidic Muscle, has long been known in itself. For example, reference can be made here to EP 0 161 750 B1 by the company Bridgestone and to publications and product descriptions of the company Festo (“Pneumatic muscle works like a real one”, Technische Rundschau [Technical Magazine] 2, 2003, page 12). Such pneumatic muscles, however, have never so far been used in the automotive sector. But there is nothing to prevent the use of pneumatic muscles in motor vehicles if an appropriately oil- and gasoline-resistant elastomeric plastic is used for the hose body.

The function of the pneumatic muscle is based on the fact that when a pressure medium, such as compressed air, flows into the hose body, the latter expands radially and, due to the effect of the relatively inextensible fibers of the lattice network, it becomes axially shorter. By virtue of this effect, a controlled feed of the pressure medium can produce a comparatively large tensile force, far greater than that of a pneumatic operating cylinder of comparable size.

Furthermore, the pneumatic muscle operates largely without friction and, therefore, shows very good response behavior without stick-slip effects. Since there are no friction-affected, articulation bearings and sealing surfaces, the pneumatic muscle is completely maintenance-free in operational service and has a very long service life. Compared with hydraulic and pneumatic operating cylinders and with electric-motor or electromagnetic actuating drives, the pneumatic muscle is considerably lighter and can also be produced more cheaply.

The closed structure of the pneumatic muscle is particularly well suited for difficult service conditions, such as exposure to dirt and water. Since heavy commercial vehicles are, in any case, provided with compressed air units, the pneumatic muscle can be used in such vehicles without much effort, i.e., both simply and inexpensively. The lattice network, preferably with a diamond-shaped mesh, can be arranged over the outside wall of the hose body as described in EP 0 161 750 B1 or it can be embedded in the material of the hose body as in the MAS pneumatic muscle from the Festo Company.

### SUMMARY OF THE INVENTION

Thanks to the large actuating force it produces and its rapid response behavior, the pneumatic muscle is particularly suitable as a clutch actuator for an automated engine clutch made as a dry clutch actuated by way of a release lever, via a release bearing, that acts in opposition to a contact pressure spring (membrane spring). For this the pneumatic muscle is expediently arranged on the tension side of the release lever, orientated substantially parallel to the movement direction of the release bearing with its end piece on the lever side articulated to the release lever and with its end piece opposite from the lever attached on the housing side. In such a case, the actuating path of the pneumatic muscle extends with a suitable lever ratio, between full engagement of the friction clutch in the rest position and full disengagement of the clutch.

However, the pneumatic muscle is also suitable as a gear actuator of an automatic transmission, for example in a motor vehicle. Thus, in the case of a shift mechanism having two shift positions and that can be actuated, via an operating sleeve, by way of a shift element made as a gearshift fork or shift rocker, the pneumatic muscle can be arranged substantially parallel to the movement direction of the operating sleeve on the tension side of the shift element relative to a neutral position with its end piece on the shift element side connected to the element and with its end piece facing away from the element attached on the housing side.

In this way, the concerned operating sleeve can be shifted back and forth by the pneumatic muscle, between two positions in which the gear is disengaged or engaged respectively. Since the pneumatic muscle is a purely tensioning element, the return of the operating sleeve to the neutral position, when the muscle is not pressurized, is expediently accomplished by a restoring spring, which can be a compression spring arranged on the same side of the shift element or as a tension spring arranged on the opposite side of the shift element.

In the case of a corresponding shift mechanism having three shift positions, it is advantageous to arrange two pneumatic muscles, one on each side of the shift element and orientated substantially parallel to the movement direction of the operating sleeve, each with its end piece on the element side connected to the shift element and its end piece facing away from the element attached on the housing side. The operating sleeve can then be moved between the shift positions G1 (first gear engaged), N (neutral, gears disengaged) and G2 (second gear engaged) so that the disengagement of a gear advantageously takes place, respectively, when the (engaging) muscle is unpressurized in addition to the elastic effect of the hose body concerned and the muscle on the opposite side is pressurized, which substantially accelerates the disengagement.

In a further preferred embodiment of a shift mechanism having two shift positions and that can be actuated via an operating sleeve by a shift rocker, the shift rocker is solidly attached to a tilt lever orientated substantially parallel to the movement direction of the operating sleeve and able to pivot about a pivot axis orientated normal to the said direction.

In this case, the pneumatic muscle is arranged on the tension side of the tilt lever a distance away from the pivot axis relative to a neutral position, orientated substantially normal to the movement direction of the operating sleeve, with its end piece on the lever side articulated to the tilt lever and with its end piece remote from the lever attached on the housing side. The operating sleeve concerned can be moved by the pneumatic muscle, between the shift positions N (neutral, gear disengaged) and G (gear engaged), and the desired force and path ratio can be produced by an appropriate choice of the lever ratio, between the tilt lever and the shift rocker.

In a corresponding shift mechanism with three shift positions and a shift rocker again solidly attached to a tilt lever orientated substantially parallel to the movement direction of the operating sleeve and able to pivot about a pivot axis orientated normal or perpendicularly to the direction, it is preferable to arrange respective pneumatic muscles with opposite action directions opposite one another, a distance away from the pivot axis and orientated essentially normal to the movement direction of the operating sleeve. The end pieces of these pneumatic muscles are each articulated to the tilt lever on the side facing the lever and attached on the housing side at the ends remote from the tilt lever.

In this case, the two pneumatic muscles can optionally be arranged relative to the shift rocker on the same side of the tilt lever and relative to the pivot axis at opposite ends of the tilt lever, i.e., both on the side of the tilt lever facing towards or facing away from the transmission shaft.

In another embodiment, the two pneumatic muscles can be arranged relative to the shift rocker on opposite sides of the tilt lever and relative to the pivot axis at the same end of the tilt lever, i.e., on a side of the tilt lever facing towards the transmission shaft and a side of the tilt lever facing away from the transmission shaft.

### BRIEF DESCRIPTION OF THE DRAWINGS

The invention will now be described, by way of example, with reference to the accompanying drawings in which:

FIG. 1A is a schematic representation of a clutch actuator device with the clutch engaged;

FIG. 1B is the clutch actuator of FIG. 1A with the clutch disengaged;

FIG. 2A is a schematic representation of a shift mechanism with two shift positions, the gear being disengaged;

FIG. 2B is the shift mechanism of FIG. 2A with gear engaged;

FIG. 3A is a schematic representation of a first shift mechanism having three shift positions, the gears being disengaged;

FIG. 3B is the shift mechanism of FIG. 3A with one gear engaged;

FIG. 4A is a schematic representation of a second shift mechanism having three shift positions, the gears being disengaged, and

FIG. 4B is the shift mechanism of FIG. 4A with one gear engaged.

### DETAILED DESCRIPTION OF THE INVENTION

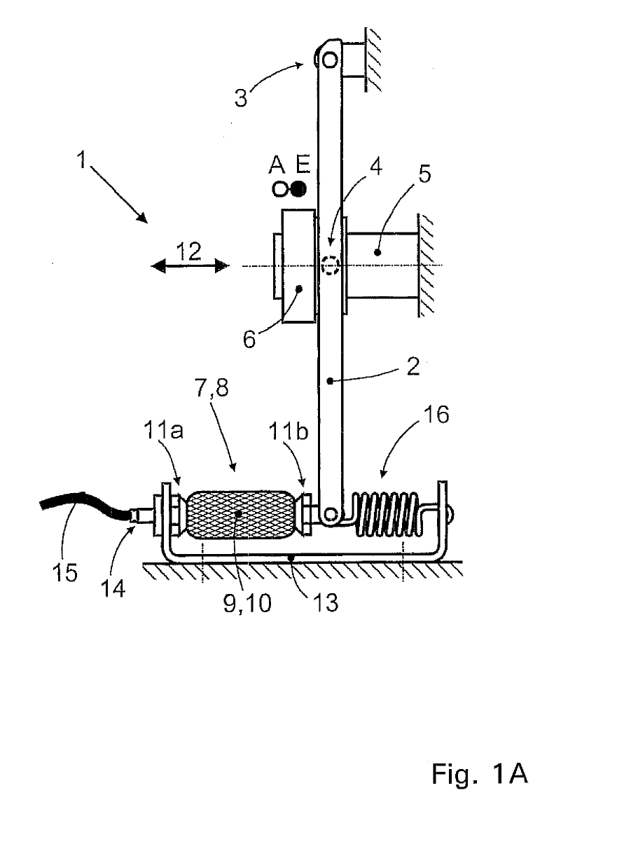

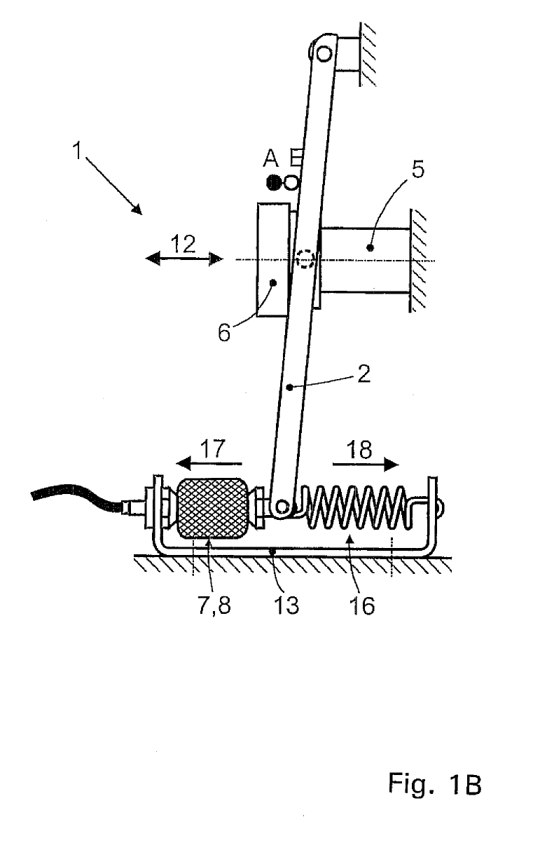

A clutch actuator mechanism 1, represented in FIGS. 1A and 1B, for a single-disk dry clutch with membrane spring (not shown in more detail), comprises a release lever 2 mounted at one end to pivot on a pivot bearing 3 fixed to a housing, engaged approximately in the middle by way of two carrier bolts 4 arranged radially opposite one another with a release bearing 6 mounted to move axially on a guide sleeve 5 fixed to the housing, and connected at its other end to a clutch actuator 7.

The clutch actuator 7 is made as a pneumatic muscle 8 with an elastic hose body 9, with a diamond-meshed lattice network 10 made of tension-resistant fibers arranged in the outer area on the hose body 9, and with end pieces 11a, 11b that close off the hose body 9 at its ends. The pneumatic muscle 8 is arranged on the tension side of the release lever 2, orientated substantially parallel to a movement direction 12 of the release bearing 6, with its end piece 11b articulated to the release lever 2 and with its end piece 11a remote from the lever attached solidly to a supporting component 13 fixed onto the housing. The end piece 11a, remote from the lever, is provided with a fitting 14 for the connection of a pressure hose 15 coming from a compressed air supply. Opposite the muscle 8, a tension spring 16 is arranged and connected at one end to the release lever 2 and at the other end to the supporting component 13.

FIG. 1A shows the engaged, actuating-force-free condition of the clutch actuator mechanism 1 in which the release bearing 6 is in its rest position E, the membrane spring is stressed and the friction clutch is, therefore, fully engaged or closed. In this condition, the pneumatic muscle 8 is not pressurized.

In FIG. 1B, the disengaged condition of the clutch actuator mechanism 1 is shown in which the release bearing 6 is in a disengaging position A, the membrane spring is not stressed and the friction clutch is, therefore, fully disengaged or open. For this, the pneumatic muscle 8 has been filled with a pressure medium, in particular compressed air, whereby the hose body 9 has been expanded radially and becomes axially shorter because of the action of the lattice network 10. This results in an axial actuating force 17 which, as a releasing force, has pivoted or moved the release lever 2 and thus also the release bearing 6 against a restoring force 18 of the membrane spring to the disengaging position A. The friction clutch can be engaged again when the pressure in the muscle 8 is released, essentially due to the restoring force of the membrane spring and also the restoring force of the tension spring 16 that acts as a restoring spring.

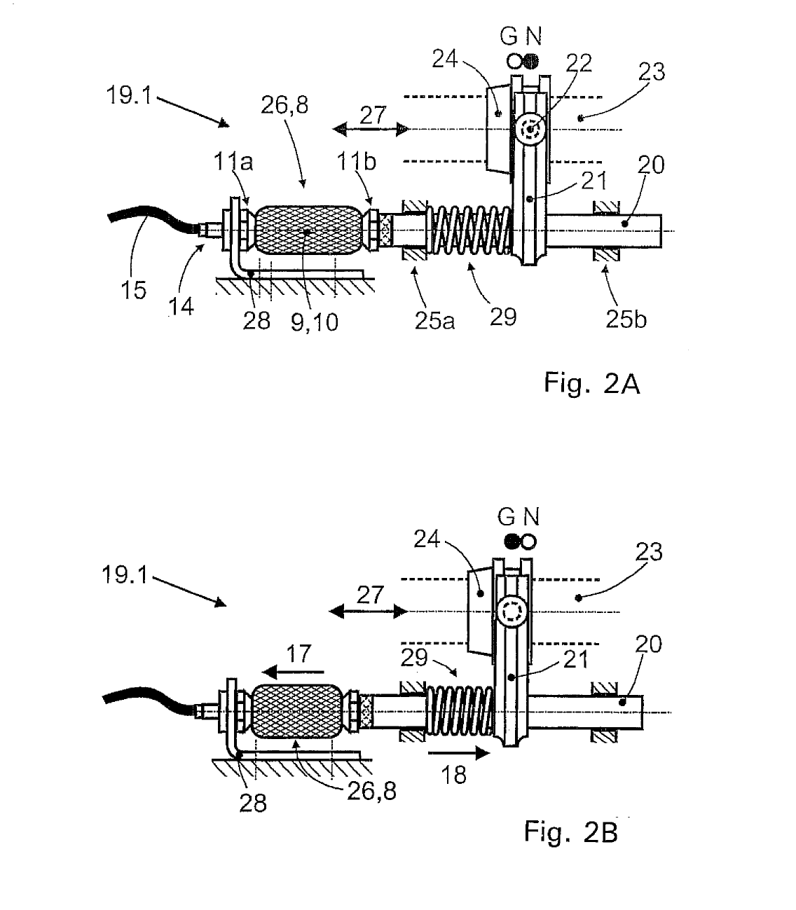

In contrast, FIGS. 2a and 2b show a shift mechanism 19.1 of a transmission (not shown in more detail), which comprises a shifting fork 21 attached solidly to a shift bar 20. By way of two carrier bolts 22, arranged radially opposite one another, the shifting fork 21 is engaged with a shifting sleeve 24 mounted to move axially on a transmission shaft 23. The fork 21 has two shift positions N in which an associated gear is disengaged, and G, in which the gear concerned is engaged.

The shift bar 20 is directed parallel to the transmission shaft 23 and is mounted to move axially in two radial bearings 25a, 25b fixed on the housing. On the tension side of the shifting fork 21, relative to a neutral position N of the shifting sleeve 24, is arranged a gear actuator 26 made as a pneumatic muscle 8, which is orientated substantially parallel to a movement direction 27 of the shifting sleeve 24, with its end piece 11b on the fork side connected to the shift bar 20 and with its end piece 11a, remote from the fork, solidly attached to a holding fixture 28 fixed on the housing. The end piece 11, a remote from the fork, is provided with the fitting 14 for the connection of the pressure hose 15 from a compressed air supply. Between the shifting fork 21 and the radial bearing 25a on the drive side, a compression spring 29 is arranged on the shift bar 20.

FIG. 2A shows the actuation-force-free, neutral condition of the shift mechanism 19.1 in which the shifting sleeve 24 is in the neutral position N, in which the associated gear is disengaged.

FIG. 2B shows the shift condition of the shift mechanism 19.1 in which the shifting sleeve 24 is in a shift position G in which the associated gear is engaged. For this, the pneumatic muscle 8 has been activated by filling with a pressure medium, in particular compressed air, whereby the hose body 9 has been made shorter and the axial actuating force 17 has been produced under the effect of which the shifting sleeve 24, by way of the shift bar 20 and the shifting fork 21, has been moved out of the neutral position N to the shift position G and the gear concerned has consequently been engaged. This has also stressed the compression spring 29. The gear is disengaged again when the pressure in the muscle 8 is released, essentially due to the restoring force 18 of the compression spring 29 acting as a restoring spring.

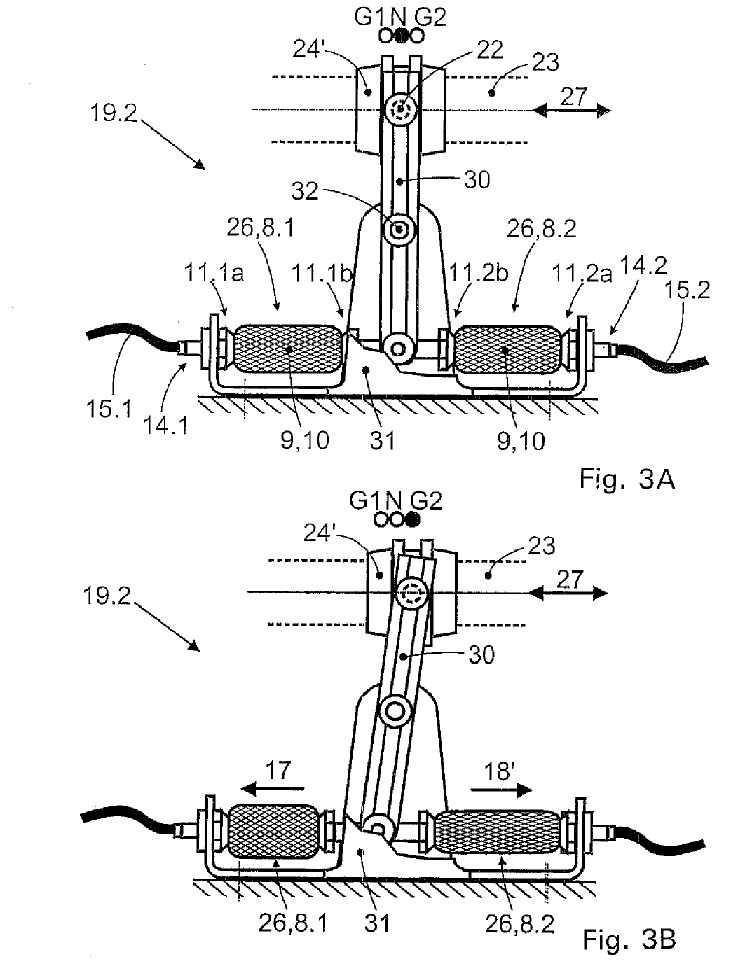

In a second preferred embodiment, according to FIGS. 3a and 3b, a shift mechanism 19.2 comprises a shift rocker 30 mounted in a bearing component 31 fixed on the housing to pivot about a pivot axis 32 positioned normal to the movement direction 27 of a shifting sleeve 24′, being engaged by way of two carrier bolts 22 with the shifting sleeve 24′ mounted to move axially on the transmission shaft 23, and being connected with two pneumatic muscles 8.1, 8.2 which constitute the gear actuator 26.

The shifting sleeve 24′ has three shift positions, G1 in which a first gear is engaged, G2 in which a second gear is engaged and the central, neutral position N in which both gears are disengaged. The two pneumatic muscles 8.1 and 8.2 are arranged on either side of the shift rocker 30, each orientated substantially parallel to the movement direction 27 of the shifting sleeve 24′, in such a manner that the respective end pieces 11.1b and 11.2b, facing the rocker, are articulated to the shift rocker 30 and end pieces 11.1a, 11.2a, remote from the rocker, are attached to the bearing component 31. The end pieces 11.1a, 11.2a remote from the rocker are provided with respective fittings 14.1 and 14.2 for the connection of pressure hoses 15.1 and 15.2 from a compressed air supply.

FIG. 3A shows the actuating-force-free, neutral condition of the shift mechanism 19.2 in which the shifting sleeve 24′ is in the neutral position N and both of the associated gears are disengaged.

FIG. 3B shows the shift condition of the shift mechanism 19.2, in which the shifting sleeve 24′ is in shift position G2, in which the second gear concerned is engaged. For this, the diagonally opposite pneumatic muscle 8.1 has been activated by filling with compressed air, whereas the other muscle 8.2 is still unpressurized. The axial shortening of the hose body 9 of the opposite muscle 8.1 produces an axial actuating force 17 under the effect of which the shifting sleeve 24′ has been moved by way of the shift rocker 30 from the neutral position N to the shift position G2 so that the second gear has been engaged. During this, the other muscle 8.2 has been elastically extended, whereby a restoring force 18′ has been produced. The second gear can be disengaged when the pressure in the muscle 8.1 is released, solely due to the restoring force 18′ of the other muscle 8.2, but this is expediently brought about much more rapidly by pressurizing the muscle 8.2.

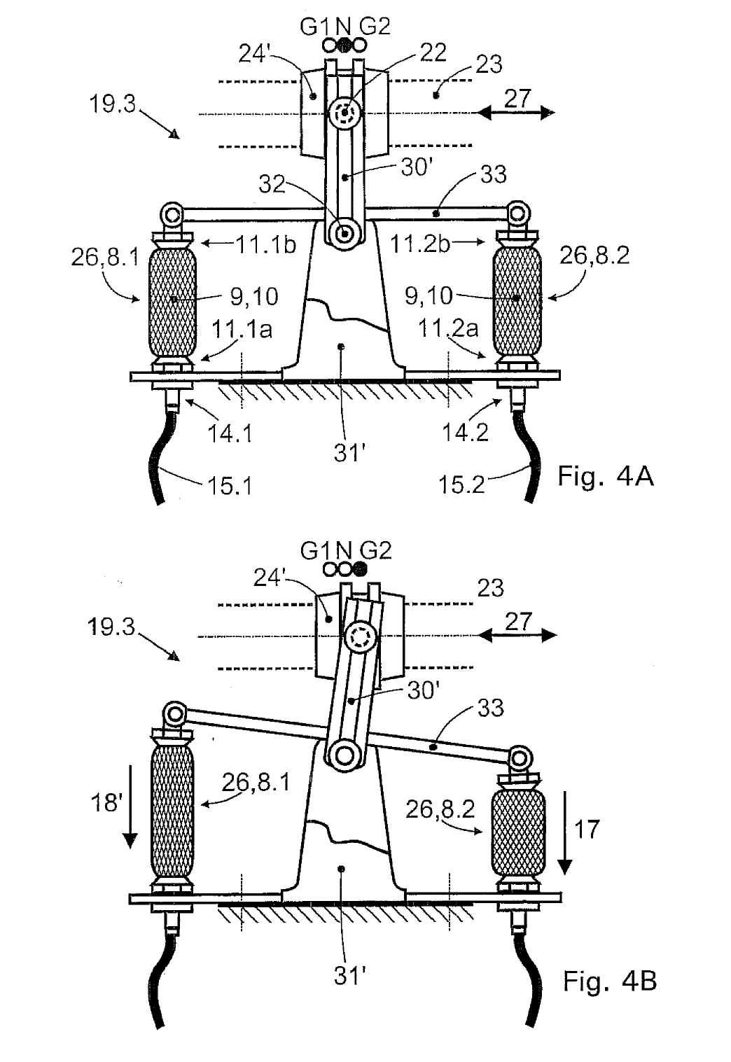

In a further preferred embodiment of a shift mechanism 19.3, shown in FIGS. 4A and 4B, a shift rocker 30′ is connected solidly to a tilt lever 33 which is orientated substantially parallel to the movement direction 27 of the shifting sleeve 24′ which has three shift positions (G1, N, G2) and which is mounted to pivot together with the shift rocker 30′ about a pivot axis 32 positioned approximately centrally and directed normal to the direction in a bearing component 31′ fixed on the housing.

At its two ends, opposite one another relative to the shift rocker 30′, the tilt lever 33 is respectively connected to pneumatic muscles 8.1, 8.2 constituting a gear actuator 26, the muscles 8.1 and 8.2 each being orientated substantially perpendicularly to the movement direction 27 of the shifting sleeve 24′, being articulated to the tilt lever 33 by their end pieces 11.1b, 11.2b on the lever side, and being attached to the bearing component 31′ by their respective end pieces 11.1a and 11.2a remote from the lever. The end pieces 11.a and 11.2a remote from the lever are each provided with fitting 14.1 and 14.2 for the connection of the pressure hose 15.1, 15.2 from a compressed air source.

FIG. 4A shows the actuating-force-free, neutral condition of the shift mechanism 19.3 in which the shifting sleeve 24′ is in the neutral position and both of the associated gears are disengaged.

FIG. 4B shows the shift condition of the shift mechanism 19.3 in which the shifting sleeve 24′ is in shift position G2 in which the second gear is engaged. For that purpose, this time the pneumatic muscle 8.2, arranged on the side of shift position G2, has been activated by filling with compressed air, whereas the other muscle 8.1 is still left unpressurized. Owing to the axial shortening of this hose body 9 of the muscle 8.2 concerned an axial actuating force 17 is produced, under whose effect the shifting sleeve 24′ has been moved by the tilt lever 33 and the shift rocker 30′ from the neutral position N to shift position G2 so that the second gear has been engaged. The other muscle 8x1 has been elastically extended, whereby the restoring force 18′ has been produced. The second gear can be disengaged again by releasing the pressure in the muscle 8.2 and by the restoring force 18′ of the other muscle 8.1 alone, although this muscle 8.1 is expediently controlled essentially by pressurizing it.

Reference numerals

| | |
|---|---|
| 1 | clutch actuator mechanism |
| 2 | release lever |
| 3 | pivot bearing |
| 4 | carrier bolts |
| 5 | guide sleeve |
| 6 | release bearing |
| 7 | clutch actuator |
| 8 | pneumatic muscle |
| 8.1 | pneumatic muscle |
| 8.2 | pneumatic muscle |
| 9 | hose body |
| 10 | lattice network |
| 11a | end piece |
| 11.1a | end piece |
| 11.2a | end piece |
| 11b | end piece |
| 11.1b | end piece |
| 11.2b | end piece |
| 12 | movement direction (of 6) |
| 13 | supporting component |
| 14 | connection fitting |
| 14.1 | connection fitting |
| 14.2 | connection fitting |
| 15 | pressure hose |
| 15.1 | pressure hose |
| 15.2 | pressure hose |
| 16 | tension spring |
| 17 | axial actuating force |
| | (due to 8, 8.1, 8.2) |
| 18 | restoring force (due to 16, 29) |
| 18′ | restoring force (due to 8.1, 8.2) |
| 19.1 | shift mechanism |
| 19.2 | shift mechanism |
| 19.3 | shift mechanism |
| 20 | shift bar |
| 21 | shifting fork |
| 22 | carrier bolts |
| 23 | transmission shaft |
| 24 | shifting sleeve |
| 24′ | shifting sleeve |
| 25a | radial bearing |
| 25b | radial bearing |
| 26 | gear actuator |
| 27 | movement direction (of 24, 24′) |
| 28 | holding fixture |
| 29 | compression spring |
| 30 | shift rocker |
| 30′ | shift rocker |
| 31 | bearing component |
| 31′ | bearing component |
| 32 | pivot axis |
| 33 | tilt lever |
| A | shift position |
| | (of 6; clutch disengaged) |
| E | shift position |
| | (of 6; clutch engaged) |
| G | shift position |
| | (of 24; gear engaged) |
| G1 | shift position |
| | (of 24′; first gear engaged) |
| G2 | shift position |
| | (of 24′; second gear engaged) |
| N | shift position |
| | (of 24, 24′; gear/gears |
| | disengaged) |

1-10. (canceled)

11. An automated transmission having at least one controllable actuating drive provided as a shift mechanism (19.1, 19.2, 19.3) for engaging and disengaging a gear of the transmission and a clutch actuator (7) for engaging and disengaging an associated automated engine clutch,
wherein the actuating drive (7, 26) includes a pneumatic muscle (8) with a hose body (9) made of a material that is impermeable to fluid and is elastic with a lattice network (10) of tension-resistant fibers arranged in an outer area of the hose body (9) and end pieces (11a, 11b) that close axial ends of the hose body (9).

12. An automated friction clutch with a controllable actuating drive provided as a clutch actuator (7) for engaging and disengaging the friction clutch, wherein the actuating drive is a pneumatic muscle (8) with a hose body (9) made of a material that is impermeable to fluid and is elastic with a lattice network (10) of tension-resistant fibers arranged in an outer area of the hose body (9) and end pieces (11a, 11b) that close both axial ends of the hose body (9).

13. The actuating drive according to claim 11, wherein the engine clutch is a dry clutch and is actuated by a release lever (2) via a release bearing (6), the pneumatic muscle (8) is arranged on a tension side of the release lever (2) and orientated substantially parallel to a direction of movement (12) of the release bearing (6), and the pneumatic muscle (8) has a first end piece (11b) coupled to the release lever (2) and an opposed second end piece (11a) remote from the lever (2) and coupled to a housing side.

14. The actuating drive according to claim 11, wherein the shift mechanism (19.1) comprises one of a shifting fork (21) and a shift rocker (30), which actuates a shifting sleeve (24) between two shift positions (G, N), the pneumatic muscle (8) is arranged on the tension side of the shift mechanism (19.1) relative to a neutral position (N) and is orientated substantially parallel to a direction of movement (27) of the shifting sleeve (24), and the pneumatic muscle (8) has end piece (11b) which communicates with the one of the shifting fork (21) and the shift rocker (30) and an end piece (11a), which is remote from the one of the shifting fork (21) and the shift rocker (30), coupled to a housing side.

15. The actuating drive according to claim 11, wherein the shift mechanism (19.2) comprises a shift element which actuates a shifting sleeve (24′) between three shift positions (G1, N, G2), respective pneumatic muscles (8.1, 8.2) are arranged on either side of the shift element and are orientated substantially parallel to a direction of movement (27) of the shifting sleeve (24′), end pieces (11.1b, 11.2b) of the respective pneumatic muscles (8.1, 8.2) are coupled to the shift element and opposed end pieces (11.1a, 11.2a), remote from the shift element, are attached on a side fixed to a housing, the shift element being one of a shifting fork (21) and a shift rocker (30).

16. The actuating drive according to claim 11, wherein the shift mechanism comprises a shift rocker (30′) which actuates a shifting sleeve (24′) between three shift positions (G1, N, G2), the shift rocker (30′) is attached to a tilt lever (33), which is orientated substantially parallel to a direction of movement (27) of the shifting sleeve (24′), and is mounted to pivot about a pivot axis (32), which is perpendicular to the direction of movement (27) of the shifting sleeve (24′), and the pneumatic muscle (8.1) is arranged a distance away from the pivot axis (32), on a tension side of the tilt lever (33) relative to a neutral position (N), and is orientated substantially perpendicular to the movement direction (27) of the shifting sleeve (24′), with a first end piece (11b) coupled to the tilt lever (33) and a second end piece (11a), remote from the tilt lever (33), coupled to a housing side.

17. The actuating drive according to claim 11, wherein the shift mechanism (19.3) is actuated by a shift rocker (30′), which actuates a shifting sleeve (24′) between three shift positions (G1, N, G2), the shift rocker (30′) is attached to a tilt lever (33), which is orientated substantially parallel to a direction of movement (27) of the shifting sleeve (24′), and is mounted to pivot about a pivot axis (32), which is perpendicular to the direction of movement (27) of the shifting sleeve (24′), respective pneumatic muscles (8.1, 8.2) having opposite action directions are arranged opposite one another a distance away from the pivot axis (32) and are orientated substantially perpendicularly to the movement direction (27) of the shifting sleeve (24′), each of the respective pneumatic muscles (8.1, 8.2) have end pieces (11.1b, 11.2b) coupled to the tilt lever (33) and opposed end pieces (11.1a, 11.2a), remote from the tilt lever (33), coupled one a housing side.

18. The actuating drive according to claim 17, wherein the respective pneumatic muscles (8.1, 8.2) are arranged on a same side of the tilt lever (33) relative to the shift rocker (30′) and at opposite ends of the tilt lever (33) relative to the pivot axis (32).

19. The actuating drive according to claim 17, wherein the respective pneumatic muscles (8.1, 8.2) are arranged on opposite sides of the tilt lever (33) relative to the shift rocker (30′) and at a common end of the tilt lever (33) relative to the pivot axis (32).

20. The actuating drive according to claim 13, wherein the release lever (2) connected to the pneumatic muscle (8, 8.1, 8.2) is connected to a restoring spring (16, 29) for automatically returning the pneumatic muscle (8, 8.1, 8.2) to a neutral position (N).

21. An automated transmission with actuator assembly (7, 26) for engaging and disengaging one of a transmission gear and a clutch, the actuator assembly (7, 26) comprising:
a sleeve (6, 24) communicating with a shaft (5, 23) coupled to the one of the transmission gear and the clutch, the sleeve (6, 24) being axially biased between at least two positions such that in a first position the one of the transmission gear and the clutch is engaged and in a second position the one of the transmission gear and the clutch is disengaged;
a shifter (2, 21, 30, 30′) being coupled to the sleeve (6, 24) for transferring an axial force to the sleeve (6, 24) and axially biasing the sleeve (6, 24) between the at least two positions; and
a pneumatic muscle (8) having a body (9) with a first end and a second end and being coupled to a source of pressure such that an interior of the body (9) is pressurizable, the first end of the body being coupled to the shifter (2, 21, 30, 30′) and the second end of the body being fixed in position with respect to the shifter (2, 21, 30, 30′), in an un-pressurized state the body having a first axial length and when pressurized the body having a second axial length longer than the first axial length, such that a pressure applied to the body, by the source of pressure, axially biases the first end away from the fixed second end causing the shifter (2, 21, 30, 30′), fixed to the first end of the body, to be biased.
